(19) United States
(12) Patent Application Publication
(10) Pub. No.: US 2013/0026974 A1
(43) Pub. Date: Jan. 31, 2013

(54) CHARGING CIRCUIT AND CHARGING CONTROL METHOD

(71) Applicant: REN-WEN HUANG, Shenzhen (CN)

(72) Inventor: REN-WEN HUANG, Shenzhen (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/249,252

(22) Filed: Sep. 30, 2011

(30) Foreign Application Priority Data
Jul. 26, 2011 (CN) 201110210464.1

(51) Int. Cl. H02J 7/00

(52) U.S. Cl. 320/107; 320/149

(57) ABSTRACT

A charging circuit for a battery includes an input terminal configured for providing a charging voltage, a switching unit connected between the input terminal and the battery, and a protection unit. The protection unit is configured for detecting a voltage of the battery and determining whether the voltage of the battery less than a predetermined voltage and controlling the switching unit to activate or terminate charging of the battery.

### BACKGROUND

1. Technical Field

The present disclosure relates to battery charging technology, and more particularly, to a charging circuit for a battery and a charging control method for a battery.

2. Description of Related Art

Many portable electronic devices include a rechargeable battery. The battery may be charged using a battery charger that includes charging circuits that provides a charging current to the battery in order to charge the battery. Once the battery is fully charged, the charging circuit should automatically cut off to terminate the charging process. Therefore, the charging circuit should be able to determine when the battery is fully charged.

An existing charging circuit includes a voltage detection element that measures an output voltage of the battery when a measured output voltage reaches a predetermined voltage (e.g., a rated voltage value). When the measured output voltage reaches the predetermined voltage, the charging circuit considers the charging process of the battery to be completed and accordingly cuts off. However, because the output voltage of the battery is measured during the charging process, due to influence of the charging current, the measured output voltage obtained by the voltage detection element is usually less than an actual available output voltage of the battery. This means the battery may not be fully charged at cutoff, resulting in a shorter time until next charge cycle of the battery and increasing the number of charges applied to the battery which can result in a shorter battery life.

What is needed, therefore, is a charging circuit which can overcome the described limitations, and a charging control method.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 shows a block diagram of a charging circuit according to an embodiment of the present disclosure.

FIG. 2 shows a circuit diagram of an embodiment of the charging circuit of FIG. 1.

FIG. 3 is a flowchart of a charging control method according to an embodiment of the present disclosure.

### DETAILED DESCRIPTION

Reference will now be made to the drawings to describe specific exemplary embodiments of the present disclosure in detail.

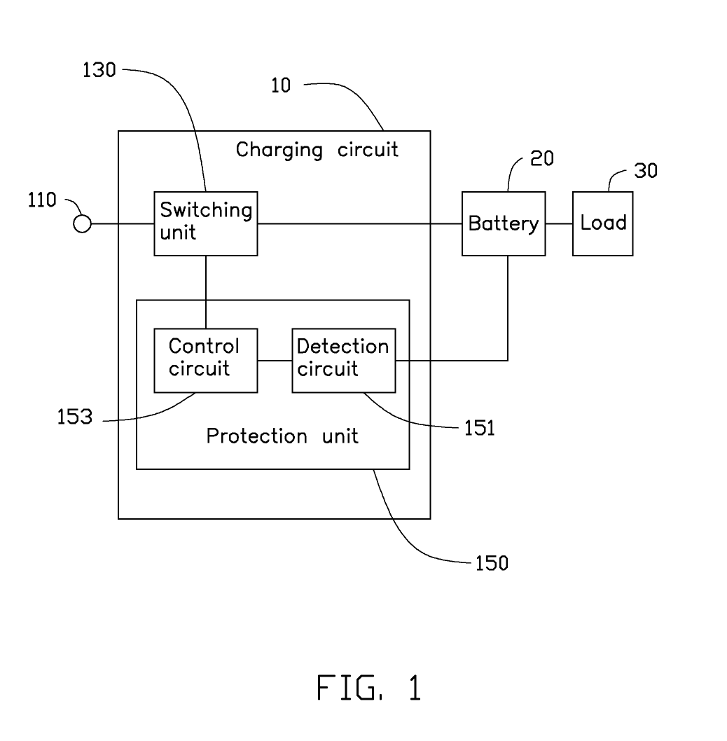

FIG. 1 shows a block diagram of a charging circuit 10 according an embodiment of the present disclosure. The charging circuit 10 is configured for charging a battery 20 which provides power to a load 30 of an electronic device. The charging circuit 10 may include an input terminal 110, a switching unit 130, and a protection unit 150. The input terminal 110 is provided with a charging voltage, and is coupled to the battery 20 via the switching unit 130. The protection unit 150 is configured for detecting a voltage of the battery 20 and outputting a control signal to switch on or switch off the switching unit 130 according to the corresponding signal of the battery 20. For example, when the corresponding signal of the battery 20 is less than a predetermined voltage, the protection unit 150 may output a first control signal to switch on the switching unit 130, such that charging of the battery 20 is activated and the battery 20 is charged by the charging voltage of the input terminal 110. When the voltage of the battery 20 is equal to or greater than a predetermined voltage, the protection unit 150 outputs a second control signal to switch off the switching unit 130 after a predetermined delay time period, such that the charging of the battery 20 is terminated. In one embodiment, for example, the predetermined voltage can be a rated voltage value of the battery 20.

The protection unit 150 may include a detection circuit 151 and a control circuit 153. The detection circuit 151 is configured for detecting the voltage of the battery 20 and outputting a corresponding signal indicating the voltage of the battery to the control circuit 153. For example, a five volt signal fed back to the control circuit can indicate twenty volts detected at the battery 20 (i.e., the battery has a twenty volt charge). The control circuit 153 is configured for comparing the corresponding signal with a reference voltage. When a voltage value of the corresponding signal is less than the reference voltage, the control circuit 153 determines the voltage of the battery 20 is less than the predetermined voltage, and outputs the first control signal to switch on the switching unit 130. When the voltage value of the corresponding signal is equal to or greater than the reference voltage, the control circuit 153 determines the voltage of the battery 20 equal to or greater than the predetermined voltage, and outputs the second control signal to switch off the switching unit 130 after the predetermined delay time period.

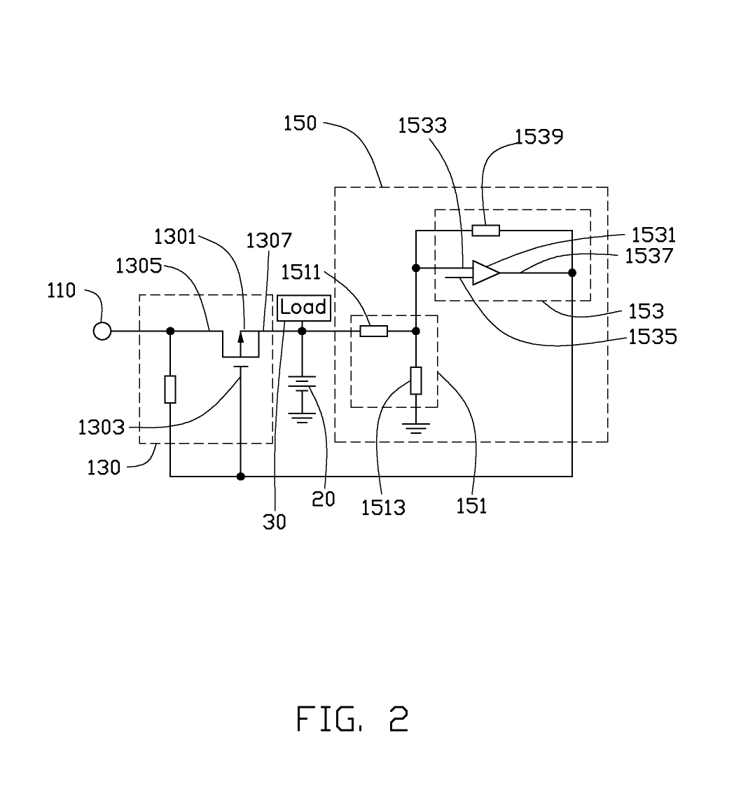

Referring to FIG. 2, a circuit diagram of an embodiment of the charging circuit 10 of FIG. 1 is shown. The switching unit 130 may include a switch element 1301. The switch element 1301 can be a p-channel field-effect transistor (FET), which includes a control terminal 1303, a first connection terminal 1305, and a second connection terminal 1307. The first connection terminal 1305 is connected to the input terminal 110 for receiving the charging voltage, the second connection terminal 1307 is connected to a positive terminal of the battery 20 for providing the charging voltage to the battery 20, and the control terminal 1303 is connected to the control circuit 153 for receiving the control signal (i.e. the first control signal or the second control signal). A negative terminal of the battery 20 may be grounded.

The detection circuit 151 may include a first resistor 1511 and a second resistor 1513. The control circuit 153 may include a Schmitt trigger, the Schmitt trigger is used to output the control signal after the predetermined delay time period, and includes an operational amplifier (op-amp) 1531 and a third resistor 1539. The operational amplifier 1531 includes a first input terminal 1533, a second input terminal 1535, and an output terminal 1537. In one embodiment, the first input terminal 1533 can be an in-phase input terminal, and the second input terminal 1537 of the operational amplifier 1531 can be an inverting-phase input terminal. The positive terminal of the battery 20 is connected to the first input terminal 1533 of the operational amplifier 1531 via the first resistor 1511, and the first input terminal 1533 of the operational amplifier 1531 is also grounded via the second resistor 1513. The third resistor 1539 is connected between the first input terminal 1533 and the output terminal 1537 of the operational amplifier 1531. The output terminal 1537 is configured for outputting the first control signal and the second control signal, and is connected to the control terminal 1303 of the switching element 1301. The second input terminal 1535 is provided with the reference voltage.

The reference voltage is a DC voltage, and a value of the reference voltage is related to the rated voltage value of the battery 20 and resistances of the first resistor 1511 and the second resistor 1513. In one embodiment, the reference voltage can follow the formula: Vr>Vs*R2/(R1+R2), where Vr represents the reference voltage, Vs represents the rated voltage of the battery 20, R1 represents a resistance value of the first resistor, and R2 represents a resistance value of the second resistor. For example, the rated voltage value of the battery 20 can be 24V (volts), a ratio between the resistances of the first resistor 1511 and the second resistor 1513 can be 1/9, and accordingly the reference voltage can be 2.5V.

In operation, the first resistor 1511 and the second resistor 1513 of the detection circuit 151 detect the voltage of the battery 20 and provide a corresponding signal to the first input terminal 1533 of the operational amplifier 1531. The operational amplifier 1531 compares the corresponding signal with the reference voltage of the second input terminal 1535. When a voltage value of the corresponding signal is less than the reference voltage, which means the voltage of the battery 20 is less than the predetermined voltage, the output terminal 1537 of the operational amplifier 1531 outputs the first control signal to switch on the switch element 1301 of the switch unit 130, and consequently, charging of the battery 20 is activated and the charging circuit 10 charges the battery 20 by use of the charging voltage. When the voltage value of the corresponding signal is equal to or greater than the reference voltage, which means the voltage of the battery is equal to or greater than the predetermined voltage, the output terminal 1537 of the operational amplifier 1531 outputs a second control signal to switch off the switch element 1301 of the switch unit 130, and consequently, the charging of the battery 20 is terminated.

It is noted that when the control circuit 153 determines that the voltage of the battery is equal to or greater than the predetermined voltage from the voltage value of the corresponding signal, due to a delay characteristic of the Schmitt trigger circuit of the control circuit 153, the second control signal is delayed to the switch unit 130 for a predetermined delay time period corresponding to the delay characteristic of the Schmitt trigger. During the predetermined delay time period, the charging voltage output to the battery 20 is maintained, to ensure the battery 20 can be truly be fully charged (that is to say the battery is topped off). By topping off the battery 20 in each charge cycle life of the battery 20, battery life of the battery 20 can be prolonged.

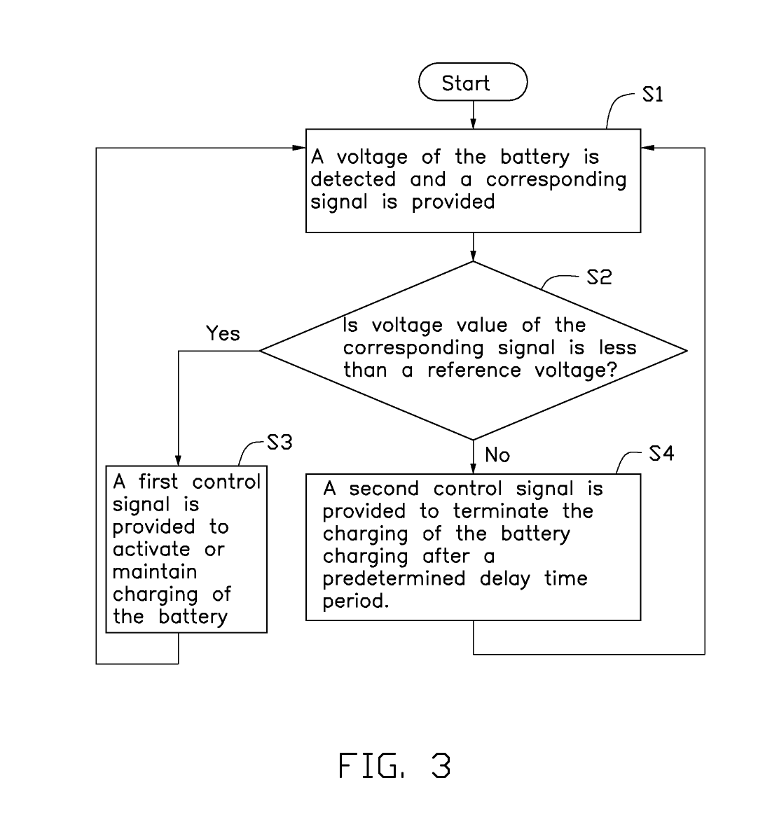

Based on the above disclosure, a charging control method is also provided. Referring to FIG. 3, a flowchart of a charging control method according to an embodiment of the present disclosure is shown. It should be understood that additional steps may be added, others deleted, and the ordering of the steps may be changed depending on the embodiment. In step S1, a voltage of the battery is detected and a corresponding signal is provided. In step S2, it is determined whether a voltage value of the corresponding signal is less than a reference voltage. If the voltage value of the corresponding signal is less than the reference voltage, step S3 is implemented. If the voltage value is not less than the reference voltage, step S4 is implemented. In step S3, a first control signal is provided to activate or maintain charging of the battery. In step S4, a second control signal is provided to terminate the charging of the battery charging after a predetermined delay time period.

The charging control method shown in FIG. 3 can be applied to the charging circuit 10 of FIG. 1, therefore, details of the steps S1-S4 of the charging control method can be referred to the above-description operation of the charging circuit 10. For example, in step S1, the detection circuit 151 detects a voltage of the battery and generates the corresponding signal. In step S2˜S4, the control circuit 153 compares the corresponding signal with a reference voltage. When a voltage value of the corresponding signal is less than the reference voltage, the control circuit 153 outputs the first control signal to switch on the switching unit 130, such that, charging of the battery is activated or maintained and the battery is charged by the charging voltage of the input terminal 110. When the voltage value of the corresponding signal is equal to or greater than the reference voltage, which means the voltage of the battery is equal to or greater than the rated voltage value, the control circuit 153 outputs the second control signal to switch off the switching unit 130 after the predetermined delay time period, such that, the charging of the battery 20 is terminated after the predetermined delay time period.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A charging circuit for a battery, comprising
an input terminal configured for providing a charging voltage,
a switching unit connected between the input terminal and the battery, and
a protection unit configured for detecting a voltage of the battery and determining whether the voltage of the battery is less than a predetermined voltage,
wherein when the voltage of the battery is less than a predetermined voltage, the protection unit outputs a first control signal to switch on the switching unit to charge the battery by use of the charging voltage; and
when the voltage of the battery is equal to or greater than the predetermined voltage, the protection unit outputs a second control signal to switch off the switching unit after a predetermined delay time period to terminate charging of the battery.

2. The charging circuit of claim 1, wherein the protection unit comprises a detection circuit and a control circuit, the detection circuit is configured for detecting the voltage of the battery and outputting a corresponding signal to the control circuit, the control circuit is configured for comparing a voltage value of the corresponding signal with a reference voltage, and outputting the second control signal to switch off the switching unit after the predetermined delay time period when the voltage value of the corresponding signal is equal to or greater than the reference voltage.

3. The charging circuit of claim 2, wherein the switching unit comprises a switch element, the switching element comprises a control terminal, a first connection terminal, and a second connection terminal, the first connection terminal is connected to the input terminal for receiving the charging voltage, the second connection terminal is connected to a positive terminal of the battery for providing the charging voltage to charge the battery, a negative terminal of the battery is grounded, and the control terminal is connected to the control circuit for receiving the first control signal or the second control signal.

4. The charging circuit of claim 3, wherein the switch element is a p-channel field-effect transistor.

5. The charging circuit of claim 3, wherein the detection circuit comprises a first resistor and a second resistor, the positive terminal of the battery is grounded via the first resistor and a second resistor in series, and a voltage of the node between the first resistor and a second resistor serves as the corresponding signal and is provided to the control circuit.

6. The charging circuit of claim 5, wherein the control circuit comprises an operational amplifier and a third resistor, the operational amplifier comprises a first input terminal, a second input terminal, and an output terminal, the first input terminal is configured for receiving the corresponding signal of the detection circuit, the second input terminal is provided with the reference voltage, the output terminal is configured for outputting the first control signal or the second control signal to the control terminal of the switching element, and the third resistor is connected between the first input terminal and the output terminal.

7. The charging circuit of claim 6, wherein the reference voltage is a DC voltage, and a value of the reference voltage is related to the predetermined voltage and resistances of the first resistor and the second resistor.

8. The charging circuit of claim 7, wherein the reference voltage follows the formula: Vr>Vs*R2/(R1+R2), where Vr represents the reference voltage, Vs represents the predetermined voltage, R1 represents a resistance value of the first resistor, and R2 represents a resistance value of the second resistor.

9. The charging circuit of claim 8, wherein the predetermined voltage is 24V, a ratio between resistances of the first resistor and the second resistor is 1/9, and the reference voltage is 2.5V.

10. The charging circuit of claim 1, wherein the predetermined voltage is a rated voltage value of the battery.

11. A charging circuit for a battery, the charging circuit comprising
an input terminal configured for providing a charging voltage,
a switching unit connected between the input terminal and the battery,
a detection circuit configured for detecting a voltage of the battery and outputting a corresponding signal, and
a control circuit configured for switching on or switching off the switching unit according to the corresponding signal,
wherein when the voltage of the battery is less than a predetermined voltage, the protection unit outputs a first control signal to switch on the switching unit causing the battery to be charged by the charging voltage; and
when the voltage of the battery is not less than the predetermined voltage, the protection unit outputs a second control signal to switch off the switching unit after a predetermined delay time period causing termination of the charging of the battery.

12. The charging circuit of claim 11, wherein the predetermined voltage is a rated voltage value of the battery.

13. The charging circuit of claim 11, wherein the switching unit comprises a switch element, the switching element comprises a control terminal, a first connection terminal, and a second connection terminal, the first connection terminal is connected to the input terminal for receiving the charging voltage, the second connection terminal is connected to a positive terminal of the battery for providing the charging voltage to charge the battery, a negative terminal of the battery is grounded, and the control terminal is connected to the control circuit for receiving the first control signal or the second control signal.

14. The charging circuit of claim 13, wherein the switch element is a p-channel field-effect transistor.

15. The charging circuit of claim 14, wherein the detection circuit comprises a first resistor and a second resistor, the positive terminal of the battery is grounded via the first resistor and a second resistor in series, and a voltage of the node between the first resistor and a second resistor serves as the corresponding signal and is provided to the control circuit.

16. The charging circuit of claim 15, wherein the control circuit comprises an operational amplifier and a third resistor, the operational amplifier comprises a first input terminal, a second input terminal, and an output terminal, the first input terminal is configured for receiving the corresponding signal of the detection circuit, the second input terminal is provided with a reference voltage, the output terminal is configured for outputting the first control signal or the second control signal to the control terminal of the switching element, and the third resistor is connected between the first input terminal and the output terminal.

17. The charging circuit of claim 16, wherein the reference voltage is a DC voltage, and a value of the reference voltage is related to the predetermined voltage and resistances of the first resistor and the second resistor.

18. The charging circuit of claim 17, wherein the reference voltage follows the formula: Vr>Vs*R2/(R1+R2), where Vr represents the reference voltage, Vs represents the predetermined voltage, R1 represents a resistance value of the first resistor, and R2 represents a resistance value of the second resistor.

19. The charging circuit of claim 18, wherein the predetermined voltage is 24V, a ratio of resistances between the first resistor and the second resistor is 1/9, and the reference voltage is 2.5V.

20. A charging control method for a battery, comprising:
detecting a voltage of the battery and outputting a corresponding signal according to the voltage of the battery,
determining whether a voltage value of the corresponding signal is less than a reference voltage,
in response to determining that the voltage value is less than the reference voltage, providing a first control signal to activate or maintain charging of the battery; and
in response to determining that the voltage value is not less than the reference voltage, providing a second control signal after a predetermined delay time period to terminate the charging of the battery.
